(19) United States
(12) Patent Application Publication
(10) Pub. No.: US 2021/0323341 A1
(43) Pub. Date: Oct. 21, 2021

(54) Trucker's Portable Workstation

(71) Applicant: John J. Gentile, Hazlet, NJ (US)

(72) Inventor: John J. Gentile, Hazlet, NJ (US)

(21) Appl. No.: 16/850,183

(22) Filed: Apr. 16, 2020

(51) Int. Cl. B42F 9/00; B43L 5/02

(52) U.S. Cl. CPC B42F 9/002; B43L 5/02

(57) ABSTRACT

A trucker's portable workstation has an elongated box member with lower and upper sections. Both the upper and lower sections have interior compartments for storing important documents and office supplies. Each of the lower and upper section compartments also have a rotatably hinged cover. The exterior of one cover provides a writing surface and a calculator and a writing pad are located on the exterior of the second cover. The bottom of the box member has non-skid surface material.

### FIELD OF THE INVENTION

The present invention relates to portable workstations for conducting office work and, more particularly, to portable workstations for use by truck drivers while they are actively conducting business in their cabs.

### BACKGROUND OF THE INVENTION

Most individuals do their office work on a desk, table, or other flat, stationary surface, whether for personal business like paying bills, writing letters, and calculating expenses, or while in the office reviewing documents, writing memos, reviewing billing, etc. Truck drivers who actively operate large rigs are similarly responsible for reviewing documents, making notes, calculating expenses, recording information, etc. while at work. Much of this office-type business activity must be done in the operator's cab of the tractor, where there is no desk or table on which to work. As a result, the trucker must somehow find a flat surface in the cab or just be content with leaning on the vehicle's console or on the vehicle's steering wheel. In addition, if important items are needed to prepare necessary documents, e.g. a calculator, diary, even pens or pencils, the trucker is required to leave his seat and search the area for the items he or she seeks.

There is currently no portable workstation specifically designed for a working truck driver which addresses these difficulties and inconveniences.

### SUMMARY OF THE INVENTION

It is thus the object of the present invention to provide a portable workstation, particularly for truck drivers and truck operators, which can be utilized directly in the cab of a tractor and which provides ready and easy access to needed office supplies and important documents.

These and other objects are accomplished by the present invention, a trucker's portable workstation having an elongated box member with lower and upper sections. Both the upper and lower sections have interior compartments for storing important documents and office supplies. Each of the lower and upper section compartments also have a rotatably hinged cover. The exterior of one cover provides a writing surface and a calculator and a writing pad are located on the exterior of the second cover. The bottom of the box member has non-skid surface material.

The novel features which are considered as characteristic of the invention are set forth in particular in the appended claims. The invention itself, however, both as to its design, construction, and use, together with additional features and advantages thereof, are best understood upon review of the following detailed description with reference to the accompanying drawings.

### BRIEF DESCRIPTION OF THE DRAWINGS

FIG. 1 is a top perspective view of the trucker's portable workstation of the present invention with its covers closed.

FIG. 2 is a top perspective view of the trucker's portable workstation of the present invention with its covers opened.

FIG. 3 is a perspective bottom review of the trucker's portable workstation of the present invention.

FIG. 4 is a view of the trucker's portable workstation of the present invention positioned for use.

### DETAILED DESCRIPTION OF THE INVENTION

Trucker's portable workstation 1 comprises elongated box member 2 having lower section 4 and upper section 14 which is shorter than the lower section.

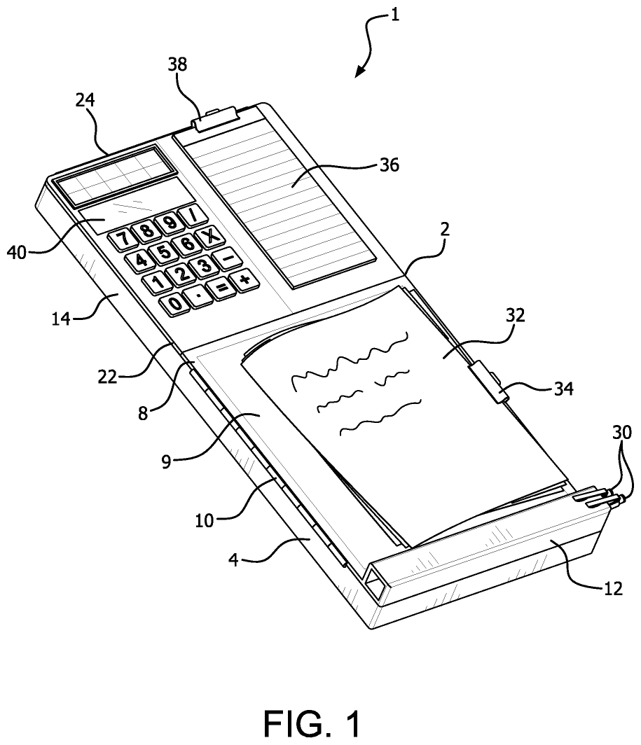

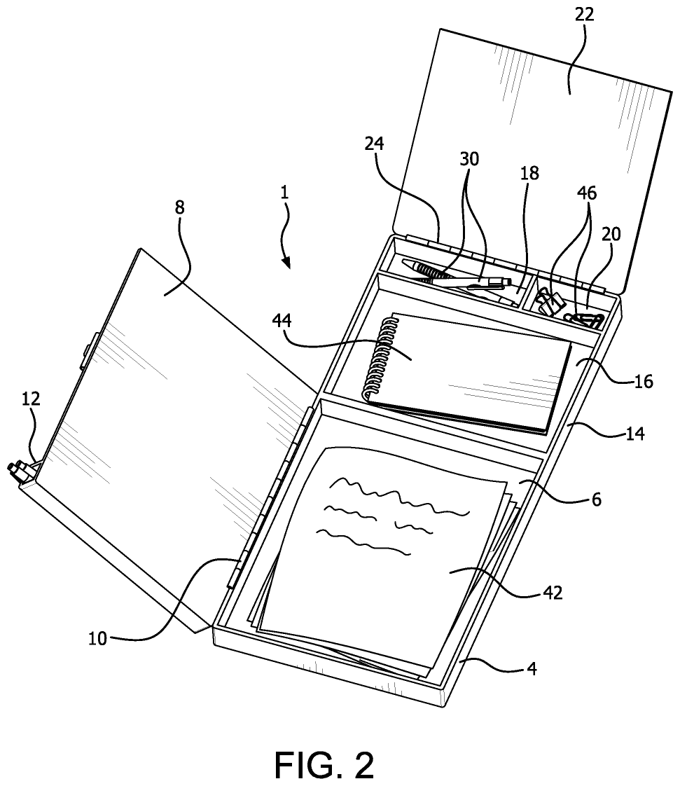

Lower section 4 comprises main interior compartment 6 and cover 8. Cover 8 is connected by permanent hinge 10 along the side of lower section 4 to allow the cover to rotate between a closed first lower cover position in which the cover overlays the lower section (see FIG. 1), to an open second lower cover position in which compartment 6 is fully exposed (see FIG. 2). Attached to cover 8 is box shaped compartment 12 with open ends. This compartment extends the entire width of the box member.

Upper section 14 comprises second interior compartment 16 and smaller interior compartments 18 and 20. Main interior compartment 6 is larger than interior compartments 16, 18, and 20 combined. Cover 22 is connected by permanent hinge 24 along the top of upper section 14 to allow the cover to rotate between a closed first upper cover position in which the cover overlays interior compartments 16, 18, and 20 (see FIG. 1), to a closed second upper cover position in which the compartments are exposed (see FIG. 2).

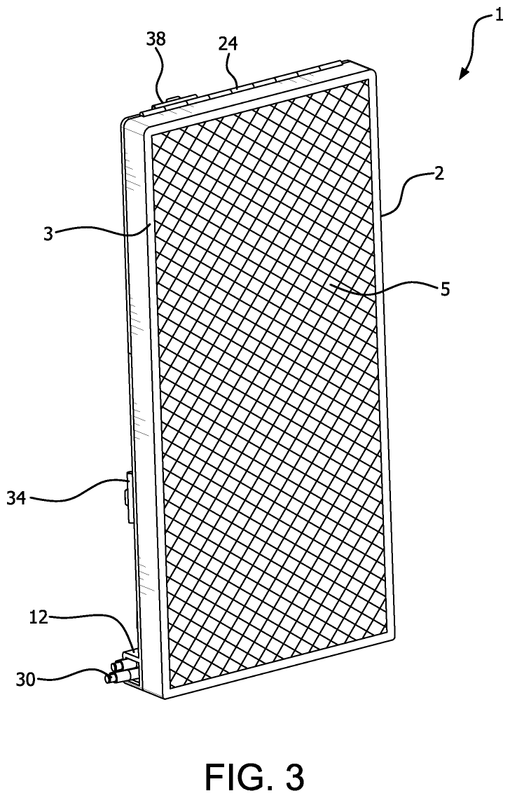

Bottom 3 of elongated box member 2 consists of a non-skid material 5 which extends the full length and width of the box member (see FIG. 3).

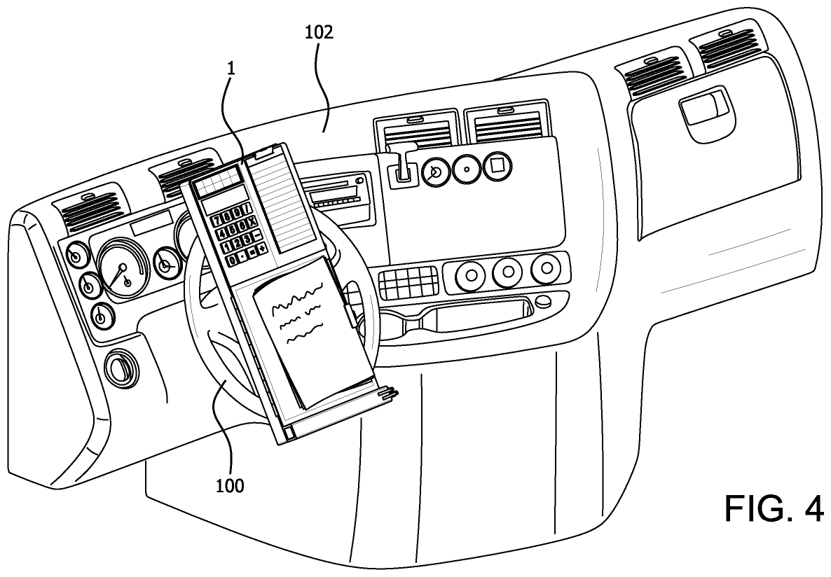

In its most common use, portable work station 1 is placed on steering wheel 100 located on vehicle console 102 (see FIG. 4). Non-skid material 5 on bottom surface 3, prevents workstation 1 from slipping off steering wheel 100. The trucker, or other vehicle operator, can then easily conduct business, by preparing his or her office paperwork and reports while remaining in the vehicle, while still having ready access to what is needed for this work. For instance, when covers 8 and 22 are in their closed positions, writing implements 30, stored within and clipped onto compartment 12, can be used to fill out paperwork 32, held in place by clip 34, directly on top surface 9 of cover 8. Notes and other information can be written on pad 36, secured by clip 38. Solar calculator 40 is available for computations.

When covers 8 and 22 are in their open positions, the trucker has access to e.g. elongated warehouse documentation 42 in compartment 6, trucker's diary 44, in compartment 16, extra writing implements 30 in compartment 18, and paper clips and other stationary items 46.

Since workstation 1 is portable, it can be used within the cab of a truck on a steering wheel as support, as well as being transported to any desired location for office work type activity.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A trucker's portable workstation comprising:
an elongated box member comprising:
a lower section and an upper section, the lower section having a main interior compartment, the upper section having a second interior compartment, smaller than the main compartment, and at least one additional interior compartment located within the second compartment;
a lower cover rotatably hinged to the lower section, wherein in a first position the cover overlays and closes off the main compartment, and in a second position, the cover exposes the main compartment;
an upper cover rotatably hinged to the upper section, wherein in a first upper cover position the upper cover overlays and closes off the second compartment and said at least said one additional compartment, and in a second upper cover position, the upper cover exposes these compartments; and
a bottom extending the full length and width of the box member, said bottom consisting of a non-skid surface material.

2. The trucker's portable workstation as in claim 1 further comprising a box shaped compartment attached to and extending the entire width of the box member.

3. The trucker's portable workstation as in claim 1 further comprising a calculator and a writing pad mounted on the upper cover.
